(19) United States
(12) Patent Application Publication
(10) Pub. No.: US 2025/0316909 A1
(43) Pub. Date: Oct. 9, 2025

(54) TUNABLE MICROWAVE/MMW REFLECTOR

(71) Applicant: ARIEL SCIENTIFIC INNOVATIONS LTD., Ariel (IL)

(72) Inventors: Amir ABRAMOVICH, Herzliya (IL); Daniel ROZBAN, Yehud (IL); David ROTSHILD, Karnei Shomron (IL)

(21) Appl. No.: 18/716,170

(22) PCT Filed: Dec. 26, 2022
(86) PCT No.: PCT/IB2022/062782

§ 371 Date: Jun. 4, 2024

Related U.S. Application Data
(60) Provisional application No. 63/293,781, filed on Dec. 26, 2021.
(60) Provisional application No. 63/353,597, filed on Jun. 19, 2022.
(60) Provisional application No. 63/395,918, filed on Aug. 8, 2022.

(51) Int. Cl. H01Q 15/14

(52) U.S. Cl. CPC H01Q 15/148

(57) ABSTRACT

Disclosed are a method of reflecting a microwave/MMW beam in a desired direction with a reflector that comprises an electromagnetic metasurface and also to a microwave/MMW reflector. In some embodiments, the reflector is tunable by projecting light (in some embodiments, the projected light constituting an image) on a portion of a reflector that includes light-sensitive components. The projecting of the light controllably sets a value of an electrical property of at least one of the light-sensitive components, where the values of the electrical property of the light-sensitive components collectively determine the phase-shift that the metasurface induces in an incident microwave/MMW beam which induced phase-shift determines the direction in which the beam is reflected.

### RELATED APPLICATION

The present application gains priority from U.S. provisional patent applications U.S. 63/293,781 filed 26 Dec. 2021, U.S. 63/353,597 filed 19 Jun. 2022, and U.S. 63/395,918 filed 8 Aug. 2022, all three which are included by reference as if fully set-forth herein.

### FIELD AND BACKGROUND OF THE INVENTION

The invention, in some embodiments, relates to the field of electromagnetic radiation and more particularly, but not exclusively, to a method of reflecting microwaves or millimeter waves in a desired direction by illuminating a portion of a reflector with light, for example by projecting an image on a portion of the reflector, and also to a microwave and/or millimeter wave reflector that is tunable by illuminating a portion of the reflector with light, for example by projecting an image on a portion of the reflector.

Microwaves are electromagnetic waves having a frequency of between 0.3 and 300 GHz. Millimeter waves (MMW) are electromagnetic waves having a frequency of between 100 and 10,000 GHz. It is known to direct a beam of microwaves or MMW from a source such as a transmitter towards a destination such as a receiver. For example, modulated microwaves and MMW are used in the field of point-to-point and multi-point wireless communications to wirelessly carry information from a transmitter to a receiver.

To increase the power received and/or the signal-to-noise ratio at the receiver and/or to prevent two different beams from interfering one with the other, it is preferred that an information-carrying microwave/MMW beam be as narrow as possible. Typically, information-carrying microwave or MMW beams have a half-power-beam width of less than 2°. A challenge is ensuring that such a narrow beam is consistently directed at the destination over a substantial distance, especially when both the source and the destination move, for example in instances when one or both are mounted on a moving object such as a tower or building that is swaying in the wind.

It is therefore desirable to have methods and/or devices that allow continuously aiming a narrow directional microwave/MMW beam from a source towards a destination, especially when either or both the source and destination are moving.

In the art it is known to achieve this goal by using a reflector bearing a plurality of scattering elements that constitute an electromagnetic metasurface to reflect an incident microwave/MMW beam in a desired direction by inducing a suitable phase shift in the incident beam.

It is also known to configure a reflector to be tunable so that the reflection-direction of an incident microwave/MMW beam can be controllably changed by allowing controllable-changing of the phase-shift induced by the metasurface of the incident beam. This can be done for horizontal and/or vertical polarization of the incident beam, depending on the geometry and arrangement of the scattering elements.

It is further known to configure such a tunable reflector to be dynamically tunable, allowing the controllable changing of the induced phase-shift in realtime.

It would be useful to have a dynamically-tunable microwave/MMW reflector that is relatively simple to make (e.g., by having relatively few electrical and control circuits) and/or that can be tuned quickly and accurately.

### SUMMARY OF THE INVENTION

The invention, in some embodiments, relates to the field of electromagnetic radiation and more particularly, but not exclusively, to a method of reflecting a microwave/MMW beam in a desired direction with a reflector that comprises an electromagnetic metasurface and to a microwave/MMW reflector that comprises an electromagnetic metasurface. In some embodiments, the reflector is tunable by projecting light (in some embodiments, the projected light constituting an image) on a portion of the reflector that includes light-sensitive components. The projecting of the light controllably sets a value of an electrical property (e.g., junction capacitance) of at least one of the light-sensitive components, where the values of the electrical property of the light-sensitive components collectively determine the phase-shift that the metasurface induces in an incident microwave or MMW beam which induced phase-shift determines the direction in which the beam is reflected.

According to an aspect of some embodiments of the teachings herein, there is provided a method for reflecting microwaves and/or millimeter waves (MMWs) in a desired direction comprising:
a. providing a microwave and/or MMW reflecting surface comprising a plurality of conductive patches on a surface of a dielectric substrate, each conductive patch in wired electrical connection with at least one light-sensitive electronic component having an electrical property that is dependent on a property (preferably the intensity) of light illuminating the light-sensitive component, where the values of the electrical property of the light-sensitive components collectively determine a phase-shift that the reflecting surface induces in an incident microwave/MMW beam which induced phase-shift determines the direction in which an incident beam is reflected; and
b. illuminating each light-sensitive component with a selected value of the property of the light (e.g., selected intensity of light) so as to set the electrical property to a desired value,
   so that a phase-shift is induced in an incident microwave/MMW beam to reflect the beam in a desired direction.

According to an aspect of some embodiments of the teachings herein, there is also provided a tunable microwave and/or MMW reflector, comprising:
a plurality of light-sensitive components having an electrical property that is dependent on a property (preferably intensity) of light illuminating the light-sensitive component; and
a microwave/MMW-reflecting surface including:
   a dielectric substrate defining an upper dielectric surface,
   on the upper dielectric surface, a plurality of conductive patches, each the conductive patch in wired electrical connection with at least one of the light-sensitive component,
      where the values of the electrical property of the light-sensitive components collectively determine a phase-shift that the microwave/MMW-reflecting surface induces in an incident microwave/MMW beam which induced phase-shift determines the direction in which an incident beam is reflected.

For the method and device, the property of light is preferably the intensity of the light, but in some embodiments the property is additionally or alternatively some other property such as the color of the light.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIGS. 1A, 1B, 1C and 1D schematically depict an exemplary embodiment of a reflector according to the teachings herein having four rows of four conductive patches in top view (FIG. 1A), side view from the x direction (FIG. 1B), side view from the y direction in cross section (FIG. 1C) and bottom view (FIG. 1D);

FIGS. 2A and 2B schematically depict an exemplary embodiment of a reflector according to the teachings herein having four rows of four conductive patches in side view from the y direction in cross section (FIG. 2A) and bottom view (FIG. 2B);

FIGS. 3A, 3B and 3C schematically depict three variants of the reflector of FIG. 1 implementing reverse bias of PIN diodes in bottom view,

FIGS. 4A, 4B and 4C schematically depict three variants of the reflector of FIG. 2 implementing reverse bias of PIN diodes in bottom view;

FIGS. 5A and 5B schematically depict an exemplary embodiment of a reflector according to the teachings in side view from the x direction (FIG. 5A) and in side view from the y direction in cross section (FIG. 5B);

FIG. 6 schematically depicts a reflector according to the teachings herein in top view where the patches are arranged with hexagonal packing;

FIGS. 7A and 7B schematically depict tuning a reflector according to the teachings herein with an image generated by an array of LEDs;

FIGS. 8A and 8B schematically depict tuning a reflector according to the teachings herein with an image generated by a projector;

FIG. 9 schematically depicts a reflector according to the teachings herein, with an LCD screen as an illumination component; and

FIGS. 10A and 10B schematically depict reflectors according to the teachings herein, each made up of multiple different dielectric substrates.

### DESCRIPTION OF SOME EMBODIMENTS OF THE INVENTION

The invention, in some embodiments, relates to a method of reflecting a microwave/MMW beam in a desired direction with a reflector that comprises an electromagnetic metasurface and to a microwave/MMW reflector that comprises an electromagnetic metasurface. In some embodiments, the reflector is tunable by projecting light (in some embodiments, the projected light constituting an image) on a portion of the reflector that includes light-sensitive components. The portion is typically, but not necessarily, on the back side of the reflector. The projecting of the light controllably sets a value of an electrical property of at least one of the light-sensitive components, where the values of the electrical property of the light-sensitive components collectively determine the phase-shift that the metasurface induces in an incident microwave or MMW beam which induced phase-shift determines the direction in which the beam is reflected. Since tuning is done wirelessly by projecting light on a portion of the reflector, in some embodiments the reflector is relatively simple to manufacture and tuning is relatively quick and accurate.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

As known in the art of metasurfaces, the reflecting metasurface of a microwave/MMW reflector can be divided into unit cells, each unit cell comprising at least part of a conductive patch (e.g., a unit cell can comprise a single conductive patch, a unit cell can comprise two halves of two different conductive patches) where the resonance of each unit cell is dependent on factors such as the physical dimensions of the unit cell, the nature of the dielectric surface, the geometry and dimensions of the constituent patch/patch parts, and the electrical properties of electronic components that are electrically connected with the patch or patches. The resonance of the unit cells making up the metasurface taken together determine the phase-shift that the metasurface induces in an incident microwave or MMW beam which induced phase-shift determines the direction in which the beam is reflected.

A reflector according to the teachings herein has a microwave/MMW-reflecting metasurface comprising a plurality of conductive patches arranged on a dielectric surface, the patches functioning as the scattering elements of the metasurface. Each conductive patch is in wired electrical connection with at least one light-sensitive electronic component. Each light-sensitive component has an electrical property (e.g., capacitance, phase, permittivity, inductance) that is dependent on a property (preferably the intensity) of light illuminating the light-sensitive electronic component. When a given light-sensitive component is illuminated with light having a given value of the property (e.g., intensity), the electrical property of the light-sensitive component adopts a value related to that value of the property of light. The value of the electrical property (capacitance, for example) of the light-sensitive component effects the resonance of the one or more patches that are in wired electrical connection with that light-sensitive component.

Since the reflective properties of the metasurface (e.g., in which direction an incident microwave/MMW beam is be reflected) are determined by the resonance of the unit cells and the resonances of the unit cells are determined in part by the value of a property (preferably the intensity) of light that illuminates each one of the light-sensitive components, it has been found and is here disclosed that it is possible to tune a reflector according to the teachings herein by projecting light at the light-sensitive components. The collection of light having selected values for one or more light properties (e.g., intensity) that illuminates each one of the light-sensitive components at any one time can collectively be considered an image. Thus, in some embodiments the reflective properties of a reflector according to the teachings herein are determined by which image is projected at the light-sensitive components.

By illuminating the light-sensitive components with the correct combination of light intensities (e.g., the correct image), the reflector is tuned to reflect an incident microwave/MMW beam in a desired direction, for example, an incident beam that interacts with the metasurface at a given incident x-angle and y-angle can be reflected from the metasurface with a selected x-angle and/or y-angle. In brief, by controlling the light illuminating the light-sensitive components, a metasurface having the desired beam-reflecting properties is constituted on the reflector. Since tuning the reflector is done wirelessly, in some embodiments a reflector according to the teachings herein can be relatively simple. In some embodiments, relatively few or no wires, electrical circuits or boards are required to control the direction to which an incident beam is reflected.

Embodiments of a reflector according to the teachings herein can be placed to receive an incident beam (e.g., from a microwave/MMW source or from another reflector) and to direct the outgoing reflected beam towards a destination (e.g., a receiver or another reflector). By selecting the correct combination of light intensities (e.g., image) to illuminate the light-sensitive components in order constitute a metasurface having the desired reflection properties, an incident beam is reflected in the desired direction, for example, at the destination, even when the source or destination are moving. Additionally, during installation of a specific reflector, the negative effects of inevitable manufacturing imperfections (e.g., negative effects such as dispersion of a reflected beam, destructive interference during interaction with the substrate, increased reflected beam side lobes at the expense of the main lobe and DC circuit losses) can be compensated for by appropriately illuminating the light-sensitive components.

Additionally or alternatively, in some embodiments a single reflector is used as a multiplexing component, for example, reflecting a beam from a single source to two or more different destinations, reflecting beams from two or more destinations to a single destination, or reflecting beams from two or more different sources to two or more different destinations.

Additionally or alternatively, in some embodiments, the methods and reflectors according to the teachings herein are used for beam forming.

### Method of Reflecting Microwaves/MMW

Thus, according to an aspect of some embodiments of the teachings herein there is provided a method for reflecting microwaves and/or MMW in a desired direction comprising:
a. providing a microwave and/or MMW reflecting surface comprising a plurality of conductive patches on a surface of a dielectric substrate, each conductive patch in wired electrical connection with at least one light-sensitive electronic component having an electrical property that is dependent on a property (preferably the intensity) of light illuminating the light-sensitive component, where the values of the electrical property of the light-sensitive components collectively determine the phase-shift that the reflecting surface induces in an incident microwave/MMW beam which induced phase-shift determines the direction in which an incident beam is reflected; and
b. illuminating each light-sensitive component with a selected value of the property of the light (e.g., selected intensity of light) so as to set the electrical property to a desired value,
   so that a phase-shift is induced in an incident microwave/MMW beam to reflect the beam in a desired direction. In preferred embodiments the surface of the dielectric substrate is planar.

In some embodiments, a reflector according to the teachings herein comprises a printed circuit board having a microwave and/or MMW reflecting surface. Alternatively, in some embodiments a reflector according to the teachings herein comprises an integrated circuit having a microwave and/or MMW reflecting surface.

The electrical property of the at least one light-sensitive component connected to a given conductive patch that is dependent on a property (such as the intensity) of light illuminating the light-sensitive component is any suitable electrical property that changes the resonance of a unit cell of which the patch is part as this effects the phase shift induced in an incident microwave/MMW beam by the conductive patch. In some embodiments, the electrical property that is dependent on a property (such as the intensity) of light illuminating the light-sensitive component is selected from the group consisting of capacitance, phase, permittivity, inductance and combinations thereof.

Any suitable light-sensitive component may be used. In some embodiments a light-sensitive component selected from the group consisting of a PN diode, a PIN diode, a PPD (pinned photodiode), a CCD (charge-coupled device), a photoresistor, a phototransistor and a Schottky Barrier Photodiode. In some embodiments where a reflector comprises a printed circuit board, one or more of the light-sensitive components is a physically-separate electronic component which is functionally-associated with the dielectric board during assembly of the reflector. In some embodiments where a reflector comprises an integrated circuit, one or more of the light-sensitive components is printed on the surface of a chip of semiconductor material such as silicon, silicon carbide, gallium nitride, graphene or gallium arsenide (GaAs).

The illumination light is any suitable light and is determined primarily by the characteristics and properties of the specific light-sensitive component that is used. Typically, the illumination light comprises, and in some embodiments consists of, light having a wavelength of between 400 micrometers and 2000 micrometers.

In some embodiments the method is implemented so that the reflector has only two possible states: either simultaneously illuminating all of the light-sensitive components with light (all-white image, in some embodiments with some predetermined variation of intensity, in some embodiments all light-sensitive components illuminated with an identical intensity of light) or not illuminating any of the light-sensitive components (all-black image). In some such embodiments, the method can be considered as using a reflector as a toggle or switch.

In some embodiments the method is implemented so that the reflector has only four possible states, the illuminating of the light-sensitive components being not illuminating any of the light-sensitive components (all-black image) or illuminating all of the light-sensitive components with a single intensity of light selected from the group consisting of about 33%, about 66% and at 100% intensity.

The relative spatial orientation of the light-sensitive components one to the other is any suitable relative spatial orientation. In some preferred embodiments, the light-sensitive components are arranged on a surface (in some preferred embodiments, a flat surface) and the illuminating of the light-sensitive components with light comprises projecting an image on the surface so that each one of the light-sensitive components is illuminated with a corresponding selected value for the property (e.g., intensity) of light. In some such embodiments, the illumination light can be considered to be an image having a pixel that corresponds to each one of the light-sensitive components.

In some embodiments, the conductive patches are electrically isolated one from the other except through one or more light-sensitive components.

In some embodiments, the plurality of conductive patches are arranged on the surface (in some preferred embodiments, a flat surface) of the dielectric substrate (e.g., PCB or chip) in a two-dimensional array having n rows, each row having m conductive patches, n and m being integers of at least 2, at least 4, at least 5, at least 6, at least 8 and even at least 9. In some such embodiments, m and n are equal. Alternatively, in some embodiments, m and n are not equal.

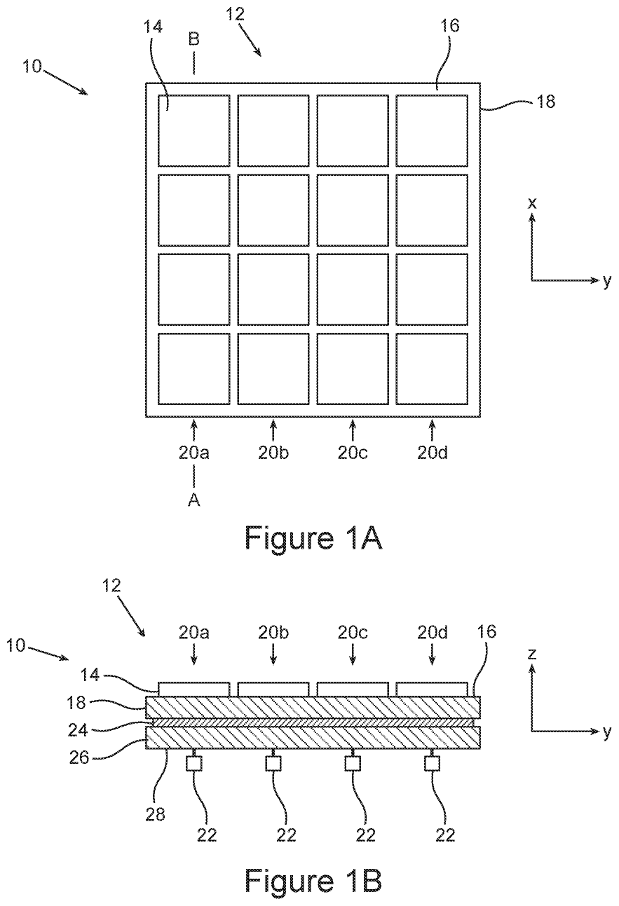

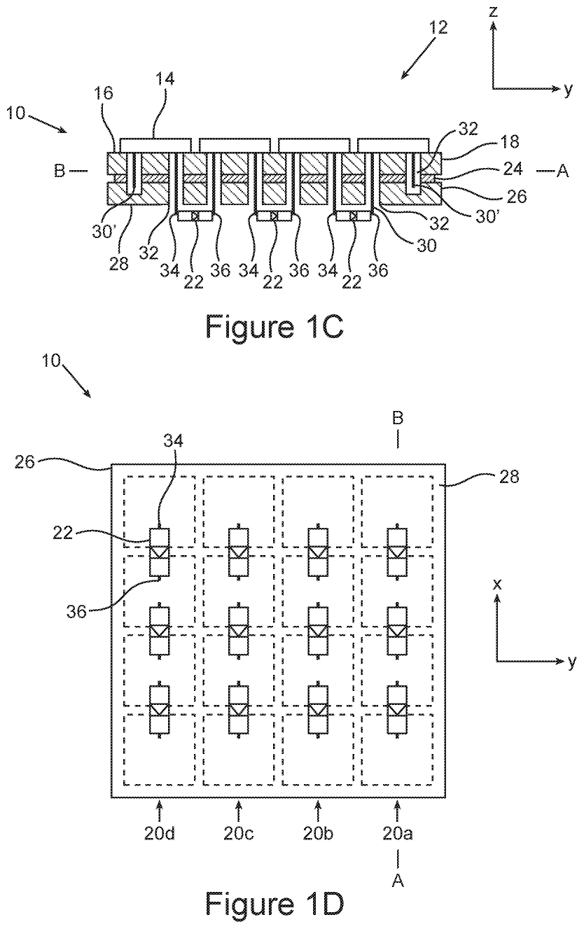

In some embodiments where the patches are arranged in rows on the surface of the dielectric substrate, adjacent patches in the same row are in wired electrical connection through a light-sensitive components and are electrically isolated from patches in different rows. Such embodiments are discussed in greater detail with reference to FIGS. 1A-1D, 3A-3C and 5A-5B.

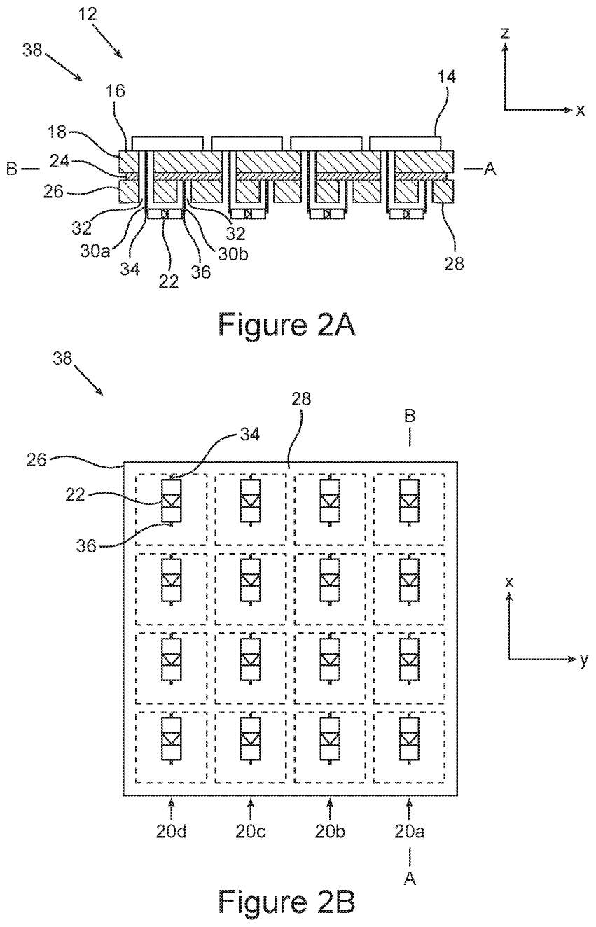

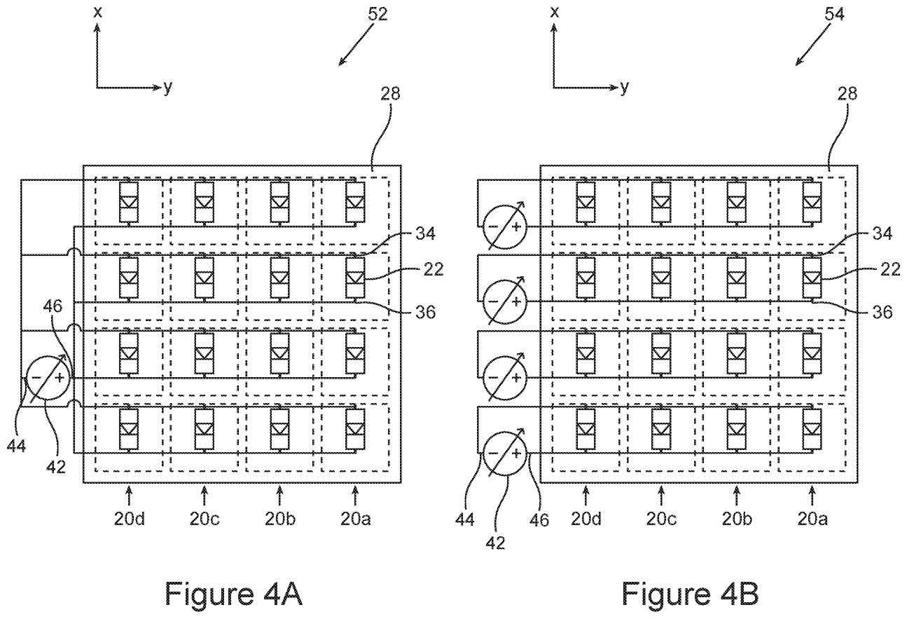

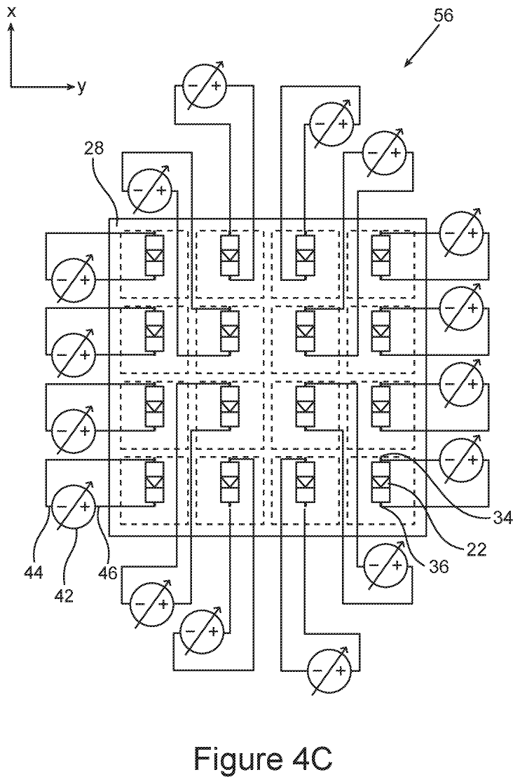

Alternatively, in some embodiments, the reflector further comprises a conductive ground component and each light-sensitive component is in wired electrical connection with a single patch and with the conductive ground component. In some preferred embodiments, the conductive ground component is a floating ground. Such embodiments are discussed in greater detail with reference to FIGS. 2A-2B and 4A-4C.

The method according to the teachings herein may be implemented using any suitable device or combination of devices. In some preferred embodiments, the method is implemented using a reflector according to the teachings herein.

### Reflector

A reflector according to the teachings herein is a microwave and/or MMW reflector that includes a dielectric surface on which are found a plurality of conductive patches, each patch in wired electrical connection with at least one light-sensitive component having an electrical property that is dependent on a property (such as the intensity) of light illuminating the light-sensitive component. Changing the values of the property of the light that is illuminating the light-sensitive components changes the reflective properties of the reflector in accordance with the teachings herein.

Thus, according to an aspect of some embodiments of the teachings herein, there is also provided a tunable microwave and/or millimeter wave (MMW) reflector comprising:
a plurality of light-sensitive components having an electrical property that is dependent on a property (preferably the intensity) of light illuminating the light-sensitive component; and
a microwave/MMW-reflecting surface including:
   a dielectric substrate defining an upper dielectric surface,
   on the upper dielectric surface, a plurality of conductive patches, each patch in wired electrical connection with at least one light-sensitive component,
      where the values of the electrical property of the light-sensitive components collectively determine a phase-shift that the microwave and/or MMW reflecting surface induces in an incident microwave/MMW beam which induced phase-shift determines the direction in which an incident beam is reflected. Preferably, the conductive patches are physically separate one from the other on the upper dielectric surface. In preferred embodiments the upper dielectric surface is planar.

The word “upper” in the term “upper dielectric surface” does not necessarily indicate an orientation, but is only added to make the description of the reflector readable to a person having ordinary skill in the art.

### Dielectric Substrate

The dielectric substrate is any suitable dielectric substrate.

In some embodiments, the dielectric substrate is a board (such as a PCB board) having a first planar surface that is the upper dielectric surface of the reflector and a second planar surface that is a planar lower surface of the board. In some embodiments, such a second planar surface is a lower surface of the reflector. Alternatively, in some embodiments, such a second planar surface is not a lower surface of the reflector. The separation of the two surfaces (the thickness of the dielectric substrate board) is any suitable separation. In some such embodiments, the dielectric substrate is at least 0.1 mm and not more than 10 mm thick. In the experimental section is described a reflector having a 508 micrometer thick dielectric substrate.

In some embodiments, the dielectric substrate is a chip of semiconductor material such as silicon or GaAs as known in the art of integrated circuits. In preferred such embodiments, one side of the chip is the reflecting surface on which are present the plurality of the conductive patches, the other side is a surface on which are present the light-sensitive components (GaAs photodiodes on GaAs substrate, for example), and a given conductive patch is in wired electrical connection with a given light-sensitive component in any suitable way, for example, using a through-silicon or through-GaAs via (TSV/TGV). Such embodiments can be made using standard integrated circuit manufacturing techniques. In such embodiments, the semiconductor material is any suitable such material, for example silicone or germanium or GaAs. The thickness of the chip is any suitable thickness as known in the art of integrated circuits, at the current date from about 275 micrometers to about 925 micrometers, more typically between 375 micrometers and 675 micrometers, e.g., 375 micrometers, 525 micrometers or 625 micrometers and depending on the required operating frequency.

### Light-Sensitive Components

As discussed above, a suitable light-sensitive component is an light-sensitive component having a suitable electrical property which value is dependent on a property (preferably the intensity) of light illuminating the light-sensitive component. A suitable electrical property is an electrical property which value influences the resonance of the unit cell of which a conductive patch that is in wired electrical connection with the light-sensitive component is part. In some embodiments, the electrical property that is dependent on the property of light illuminating the light-sensitive component is selected from the group consisting of capacitance, phase, permittivity, inductance and combinations thereof.

Any suitable light-sensitive component may be used. In some embodiments a light-sensitive component is selected from the group consisting of a PN diode, a PIN diode, a PPD, a CCD, a photoresistor, a phototransistor and a Schottky Barrier Photodiode.

In preferred embodiments, the light-sensitive components are selected from the group consisting of PN diodes and PIN diodes.

In some embodiments, the light-sensitive components are made on the surface of a chip of semiconductor material in the usual way of integrated circuits. In some such embodiments, the dielectric substrate is a chip of semiconductor material on which one side are the light-sensitive components and on the opposite side are the reflective patches, both the light-sensitive components and the reflective patches preferably made on the respective surface in the usual way of integrated circuits. In some such embodiments, the dielectric substrate is a chip of semiconductor material on which one side are both the light-sensitive components and the reflective patches, both the light-sensitive components and the reflective patches preferably made on the same surface in the usual way of integrated circuits.

In embodiments where the dielectric substrate is a PCB, commercially-available light-sensitive components that are suitable for implementing one or more embodiments of the teachings herein include the SFH 2704 Silicon PIN photodiode by OSRAM Opto Semiconductors GmbH (Regensburg, Germany) and the BPV10 silicon PIN photodiode by Vishay Semiconductors (Malvern, Pennsylvania, USA).

In some embodiments, the light-sensitive components are not biased, e.g., the light-sensitive components are open-circuit PIN or PN diodes. Such embodiments are discussed in greater detail with reference to FIGS. 1A-1D, 2A-2B and 5A-5B. In open-circuit PN or PIN diodes, incident light of the appropriate wavelength generates electrons and holes flowing to the N- and P-type sides of the junction, narrowing the depletion region, thereby increasing the junction capacitance Cⱼ. The closer the wavelength of the light is to the ideal (according to the quantum-efficiency of the light-sensitive component), and the higher the intensity of the light, the larger the junction capacitance Cⱼ.

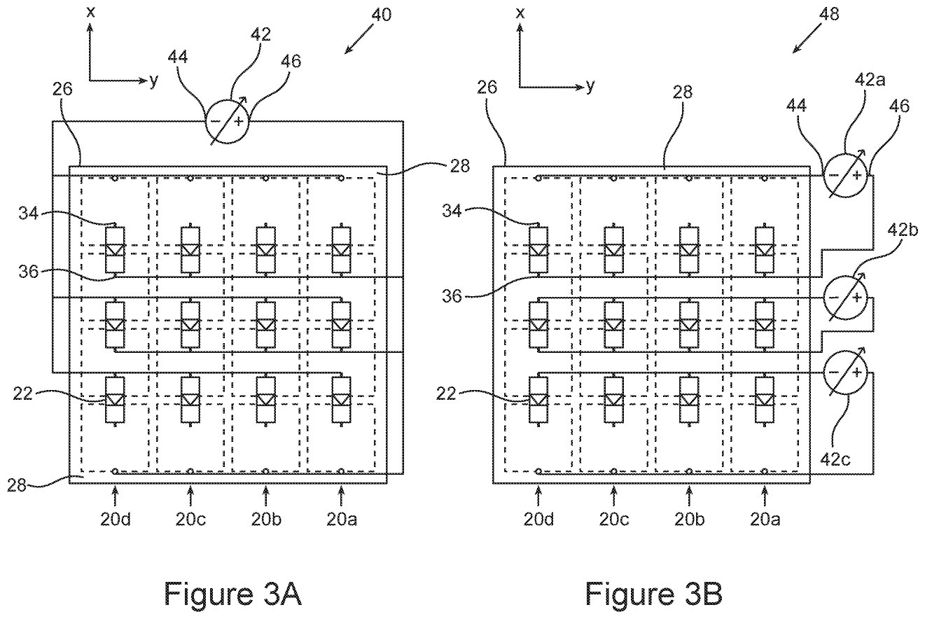

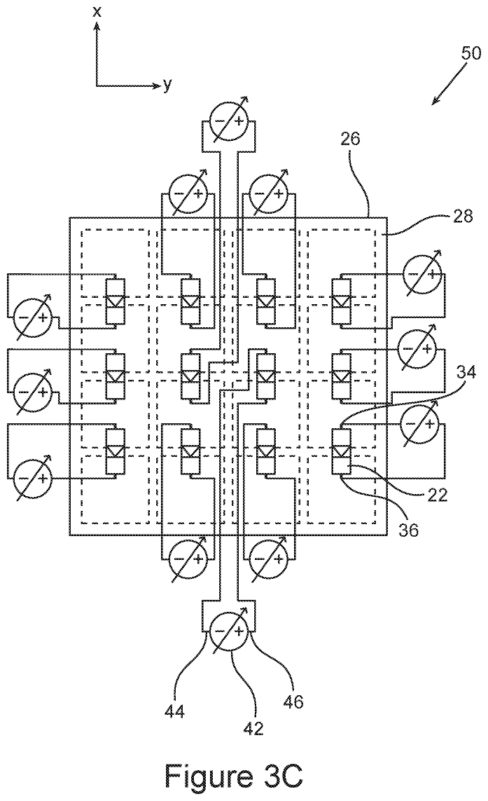

Alternatively, in some embodiments the light-sensitive components are reverse-biased, e.g., the light-sensitive components are reverse-biased PIN or PN diodes. Such embodiments are discussed in greater detail with reference to FIGS. 3A-3C and 4A-4C. When a PN or PIN diode is reverse-biased, the dynamic range of the junction capacitance Cⱼ increases. In some embodiments, PIN diodes are preferred to PN diodes as PIN diodes react more quickly to changes in illumination than PN diodes when exposed to light (in the order of several tens of GHz), PIN diodes have a better long wavelength response and superior quantum efficiency than PN diodes. PIN diodes typically have 50%-90% quantum efficiency in the visible (Silicon PIN PD) and near IR (InGaAs PIN PD) region.

In embodiments where the light-sensitive components are PN or PIN diodes, any suitable type of diode material can be used. In some embodiments, Si diodes are preferred as these have a high quantum efficiency, but only when illuminated with wavelengths less than 1100 nm, for example 400-950 nm. In alternate preferred embodiments, Ge, GaAs or InGaAs diodes are preferred, especially PIN diodes, as these have extremely fast response times when illuminated with light having 1300-1500 nm wavelength. In some embodiments where the dielectric substrate is a chip of semiconductor material, the light-sensitive components preferably comprise or consist of germanium, GaAs or InGaAs. In such embodiments, the surface area that each light sensitive component occupies on the surface of the chip is typically not more than about 0.01 mm² (equivalent to a 100 micrometer by 100 micrometer square).

TABLE
Typical Photodetector Characteristics

| | wavelength | responsivity | dark current | rise time |
|---|---|---|---|---|
| photodetector | [nm] | [A/W] | [nA] | [ns] |
| Silicon PIN | 550-850 | 0.41-0.7 | 1-5 | 5-10 |
| Silicon PIN | 850-950 | 0.6-0.8 | 10 | 0.070 |
| InGaAs PIN | 1310-1550 | 0.85 | 0.5-1.0 | 0.005-5 |
| InGaAs APD | 1310-1550 | 0.80 | 30 | 0.100 |
| Germanium | 1000-1500 | 0.70 | 1000 | 1-2 |

### Second Surface

The light-sensitive components are attached to the other components of the reflector in any suitable fashion.

In some embodiments, the light-sensitive components are arranged on the same surface as the reflective patches.

In some preferred embodiments, the reflector comprises a second surface on which the light-sensitive components are arranged. In some such embodiments, the second surface is planar. In preferred such embodiments, a planar second surface is parallel to the upper dielectric surface. In some embodiments, such a second planar surface is a lower surface of the reflector. In some embodiments, the second surface is a second dielectric surface.

In some alternative embodiments, the second surface on which the light-sensitive components are arranged is of a component that is different from the component on which first surface the reflective patches are arranged.

### Second Dielectric Substrate

In some embodiments, a second dielectric surface is a surface of a second dielectric substrate different from the dielectric substrate which defines the upper dielectric surface.

In some embodiments, the second dielectric substrate is a board having a first planar surface that is the second dielectric surface of the reflector and an upper planar surface that is a planar upper surface of the board. The separation of the two surfaces (the thickness of the second dielectric substrate board) is any suitable separation. In some such embodiments, the dielectric substrate is at least 0.1 mm and not more than 10 mm thick. In the experimental section is described a reflector having a 127 micrometer thick second dielectric substrate.

As noted above, in some embodiments where the dielectric substrate is a chip of semiconductor material, the first dielectric surface is the first (front side) reflective surface of the chip and the second dielectric surface is the opposite surface of the chip (back side) that bears the light-sensitive components.

### Conductive Ground Component

In some embodiments, the reflector comprises a conductive ground component.

In some embodiments, the dielectric substrate and a second dielectric substrate are separated by such a conductive ground component. In some such embodiments, the ground component is a planar component (e.g., a layer of conductive material) that contacts a planar lower surface of the dielectric substrate and a planar upper surface of the second dielectric substrate. In some such embodiments, the ground component is not less than 1 micrometer thick and not more than 200 micrometers thick. In the experimental section is described a reflector having a 50 micrometer thick planar conductive ground component.

In some embodiments, the conductive ground component is configured to be grounded during operation of the reflector. In preferred embodiments, the conductive ground component is not grounded during operation of the reflector. In some preferred embodiments, the conductive ground component is configured as a floating ground. Embodiments of a reflector having a floating ground component are depicted, inter alia, in FIGS. 1A-1D and 2A-2B.

In some embodiments, at least some of the patches are in wired electrical connection with at least one of the light-sensitive component through a conductor that passes through the dielectric substrate, a conductive ground component and a second dielectric substrate without electrical contact with the conductive ground component. In some such embodiments, the dielectric substrate and the second dielectric substrate are PCB boards and the conductive components that pass through the dielectric substrate, the conductive ground component and the second dielectric substrate are vias. Such embodiment are depicted, inter alia, in FIGS. 1 and 2.

### Patches

The patches are made in any suitable way, have any suitable geometry, are of any suitable arrangement, are of any suitable size and any suitable number as is known to a person having ordinary skill in the art of metasurfaces.

In some preferred embodiments, the patches are a layer of conductive material on the upper dielectric surface of the dielectric substrate. In some such embodiments, for example when the device is implemented as a PCB, the patches are of a conductive material between 1 micrometer and 200 micrometers thick, preferably between 50 micrometers and 100 micrometers thick. In the experimental section is described a reflector having 50 micrometer thick patches of copper.

In some alternative preferred embodiments where the device is implemented as an integrated circuit, the patches are a layer of conductive material on a (front) surface of the chip having any suitable dimensions and any suitable thickness as known in the art of integrated circuits. In such embodiments, the thickness of the patches is typically between about 1 micrometer and about 100 micrometers, preferably between 10 micrometers and about 50 micrometers, for example between about about 20 micrometers and about 40 micrometers such as about 35 micrometers thick.

As noted above, the conductive patches are preferably physically separate one from the other on the upper dielectric surface. The separation between any two neighboring is any suitable separation. In some embodiments, the patches are separated by a distance of not less than 1 nm (7 copper atom radii) and not more than 5000 micrometer, depending on the intended operation frequency of the reflector. As known to a person having ordinary skill in the art of metasurfaces, the separation influences the resonance of the reflector unit cells and is generally determined by the designed operating frequency of the reflector. In the experimental section are described reflectors where neighboring patches are separated by 0.24 mm. In some embodiments, a reflector has different separations for different patches as known in the art of metasurfaces, see for example Litmanovitch, Rothshild and Abramovich in Chinese Optics Letters 2017, 15(1), 011101.

The patches may be made in any suitable way of any suitable material, preferably a metal. In some embodiments where the device is made using PCB technology the patches are made, for example in the usual way known in the art of PCB manufacture by etching (chemically, mechanically, laser) of a copper foil on the upper surface of a PCB or by vapor deposition. In some embodiments where the device is made using integrated circuit technologies, the patches are made in the usual way of integrated circuit manufacture, including, optionally, a protective layer using any suitable technology, for example, a gold, aluminum or silver protective layer.

The patches are of any suitable size. In some embodiments, all of the patches of the reflector have within about 5% of the same surface area (in the x-y plane of the upper dielectric surface), more preferably within about 3% of the same surface area. In some alternative embodiments, a single reflector includes patches of different sizes, see for example Litmanovitch, Rothshild and Abramovich in Chinese Optics Letters 2017, 15(1), 011101.

The size of a given patch and associated unit cell is any suitable size. As known to a person having ordinary skill in the art of metasurfaces, the size of the unit cell generally determines the wavelength of microwaves/MMW that can be effectively reflected by the reflector. The relationship of wavelength to the size of a patch or unit cell is discussed in greater detail below.

In some embodiments, each patch covers a surface area of not less than about 0.25 mm² (equivalent to a 0.5 mm×0.5 mm square patch) and not more than about 100 mm² (equivalent to a 10 mm×10 mm square patch) of the upper dielectric surface. In some embodiments, each patch covers a surface area of not less than about 1 mm² (equivalent to a 1 mm×1 mm square patch) of the upper dielectric surface. In some embodiments, each patch covers a surface area of not more than 25 mm² (equivalent to a 5 mm×5 mm square patch) of the upper dielectric surface. In the experimental section is described a reflector having 1.36 mm×1.36 mm square patches.

### Patch Shape

The patches are of any suitable shape, as known to a person having ordinary skill in the art of metasurfaces, including square, rectangular, polygonal circular, cross-shaped, star-shaped, Jerusalem cross shaped, split-ring shaped (e.g., split-ring resonators, dual split-ring resonators, square, circular) and fishnet patches. In some embodiments, all of the patches of a reflector have the same shape. Alternatively, in some embodiments, a single reflector comprises patches having different shapes.

In some embodiments, the patches are substantially square-shaped, having a width dimension within about 10% of a length dimension and four internal angles of about 90°±3° and more preferably square shaped having a width dimension within about 2% of a length dimension and four internal angles of about 90°±1°.

### Number of Patches

The number of patches is any suitable number of patches, as known to a person having ordinary skill in the art of metasurfaces. In some embodiments a reflector includes at least four patches, at least sixteen, at least 25, at least 36, at least 64 and even at least 81 patches. In FIGS. 1A-1D and 2A-2B are described reflectors each having 16 patches. In the Experimental section is described a reflector having 256 patches.

### Arrangement of Patches on the Surface

The patches are arranged on the upper dielectric surface in any suitable arrangement as known to a person having ordinary skill in the art of metasurfaces.

In some embodiments, the patches are arranged on the upper dielectric surface in a two-dimensional array having n rows, each row having m conductive patches, n and m being integers of at least 2 (square packing). In FIGS. 1A-ID and 2A-2B are described reflectors each having 16 patches arranged in four rows of four patches each. In the Experimental section is described a reflector having 16 rows of 16 patches each.

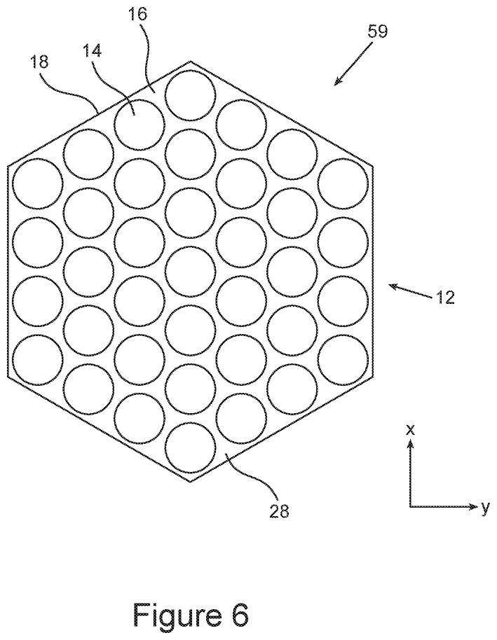

In some alternative embodiments, the patches are hexagonally-packed on the upper dielectric surface, in some such embodiments the patches are circular. In FIG. 6 is schematically depicted a reflector having hexagonally-packed circular patches.

Other embodiments having other suitable arrangements of patches are not described for brevity.

### Size of the Reflecting Surface

The size of the reflecting surface of a reflector is any suitable size which is typically determined by the wavelength to be reflected and also by the size, number and arrangement and separation of the unit cells and patches as is known to a person having ordinary skill in the art of metasurfaces. Generally speaking, for reflecting microwave/MMW having a wavelength λ₀, the dimensions of a reflecting surface are preferably at least about 10 λ₀, where the larger the reflector dimensions the better the reflector performances. Further, to effectively reflect microwaves or MMW having a wavelength λ₀, the unit cell and the patches of the reflector preferably have in-plane dimensions (x and y dimensions that are in the plane of the upper dielectric surface (front side) that are not more than about 0.25 λ₀, preferably between about 0.10 λ₀ and about 0.25 λ₀.

In FIGS. 1A-1D and 2A-2B are depicted exemplary reflectors having sixteen 1.36 mm×1.36 mm square patches arranged in a 4×4 square array, neighboring patches separated by 0.24 mm so that the reflecting surface is a 6.4 mm×6.4 mm square. With such dimensions, the reflectors depicted in FIGS. 1A-1D and 2A-2B are not necessarily practical reflectors but are simplified drawings to allow understanding of some aspects of the invention. In the Experimental Section is described a reflector having 256 1.36 mm×1.36 mm square patches arranged in a 16×16 square array, neighboring patches separated by 0.24 mm so that the reflecting surface is a 25.6 mm×25.6 mm square.

In some embodiments, the teachings herein are directed to reflect beams of microwaves/MMW having frequencies of from about 1 GHZ (λ₀=330 mm) to about 300 GHZ (λ₀=1 mm). Based on the preferred dimensions of a reflecting surface preferably being at least about 10 λ₀, for 300 GHz radiation a reflecting surface preferably has dimensions of at least about 10 mm with patches having dimensions of between about 0.1 mm and about 0.25 mm while for 1 GHz radiation a reflecting surface preferably has dimensions of at least about 3300 mm with patches having dimensions of between about 33 mm and about 82 mm.

In some preferred embodiments, a reflector is made using PCB technology, where one side of a PCB constitutes the reflecting surface and bears the conductive patches while the opposite equally-sized side of a PCB bears the light-sensitive components. PCB boards having dimensions up to about 300 mm (e.g., 300×300 mm square PCBs or 300 mm diameter circular PCBs) are readily commercially-available and have dimensions that are suitable to reflect wavelengths from λ₀=1 mm (300 GHz) up to about 30 mm (10 GHz). Larger PCB boards are less available, more expensive and may require robust packaging to reduce the chance of breakage and assist in maintaining sufficient planarity for use.

In some preferred embodiments, a reflector is a semiconductor chip made using integrated circuit technology, where one side of the chip constitutes the reflecting surface and bears the conductive patches while the opposite equally-sized side of the chip bears the light-sensitive components. As is known, chips are made from standard-sized wafers. Currently available wafer sizes are: 51 mm diameter/275 micrometers thick wafers; 76 mm diameter/375 micrometers thick wafers; 100 mm diameter/525 micrometers thick wafers; 125 mm and 130 mm diameter/625 micrometers thick wafers; 150 mm diameter/675 micrometers thick wafers; 200 mm diameter/725 micrometers thick wafers; 300 mm diameter/775 micrometers thick wafers; and 450 mm diameter/925 micrometers wafers.

It is well-known to make multiple chips from a single wafer, for example, allowing to make small-sized reflectors according to the teachings herein suitable for reflecting short wavelength/high frequency beams. Alternatively, in some embodiments, an entire wafer is used for making a single chip that constitutes a reflector according to the teachings herein, for example: a 51 mm diameter wafer for making a reflector suitable for reflecting up to about λ₀=5 mm (60 GHz) beams; a 76 mm diameter wafer for making a reflector suitable for reflecting up to about λ₀=7 mm (43 GHZ) beams; a 100 mm diameter wafer for making a reflector suitable for reflecting up to about λ₀=10 mm (30 GHz) beams; a 125 mm/130 mm diameter wafer for making a reflector suitable for reflecting up to about λ₀=12 mm (25 GHz) beams; a 150 mm diameter wafer for making a reflector suitable for reflecting up to about λ₀=15 mm (20 GHz) beams; a 200 mm diameter wafer for making a reflector suitable for reflecting up to about λ₀=20 mm (15 GHZ) beams; a 300 mm diameter wafer for making a reflector suitable for reflecting up to about λ₀=30 mm (10 GHz) beams; and a 450 mm diameter wafer for making a reflector suitable for reflecting up to about λ₀=45 mm (6 GHz) beams.

### Composite Reflecting Surface

In some embodiments, the dielectric substrate bearing a reflecting surface of a reflector according to the teachings herein is a single physical unit, e.g., a single PCB board or a single semiconductor chip.

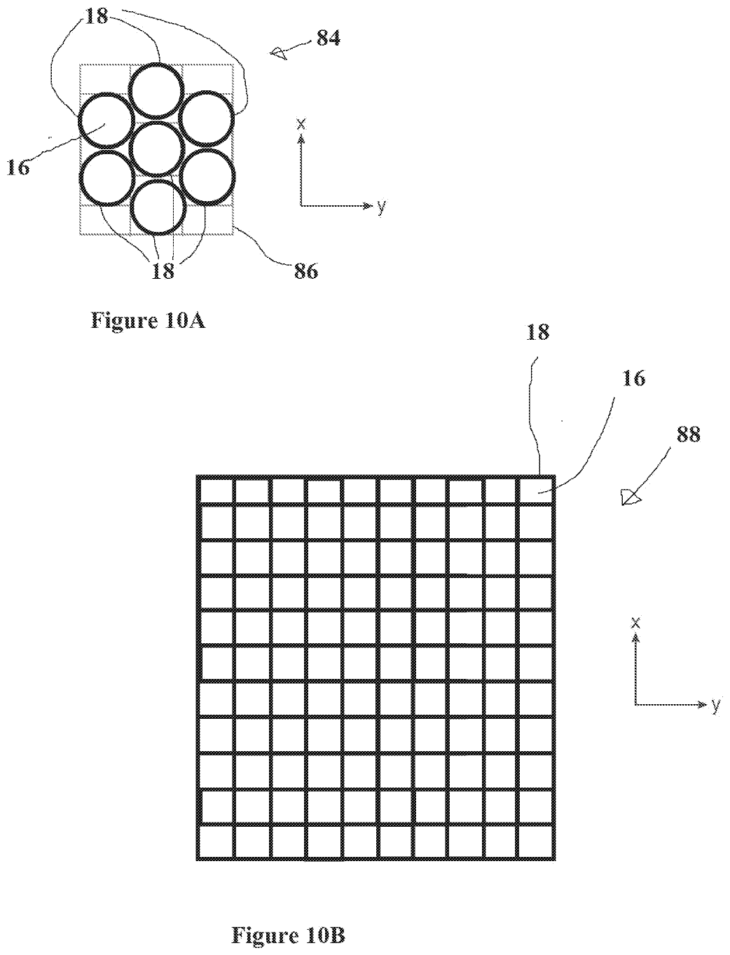

Alternatively, in some embodiments, for example in some instances when it is desired to provide a reflector suitable for efficiently reflecting relatively low frequency/long wavelength beams (e.g., λ₀=300 mm (1 GHZ) to λ₀=45 mm (6 GHZ), when it is more economical taking technical considerations into account) and/or when fragility/planarity of large-dimension boards or chips is a factor, the microwave/MMW-reflecting surface of a device comprises at least two different dielectric substrates each defining an upper dielectric surface bearing a plurality of conductive patches, e.g., at least two PCB boards or at least two semiconductor chips. Preferably, the different dielectric substrates are all coplanar. The separation between any two different dielectric substrates is any suitable separation and is typically determined by the size and arrangement of the patches on the two substrates. Since the reflective properties of the dielectric surfaces of each dielectric substrate is controlled by the illumination of the associated light-sensitive components, the coordination of the reflective properties of multiple separate dielectric substrates to function together as a single reflective surface is simple. Such embodiments are schematically depicted in FIGS. 10A-10B, discussed hereinbelow.

Wired Electrical Connection of Patches with the Light-Sensitive Components

Each conductive patch of a reflecting surface of a reflector according to the teachings herein is in wired electrical connection with at least one light-sensitive component having an electrical property that is dependent on a property of light illuminating the light-sensitive component. The wired electrical connection is such that a change in the value of the electrical property of the light-sensitive component as a result of a change in illumination of the light-sensitive component, leads to a change in the resonance of the unit cell of which the light-sensitive component is part.

Wired Electrical Connection of Single Patch with Multiple Light-Sensitive Components

In some embodiments, at least 50% of the patches are in wired electrical connection with two light-sensitive components. Such embodiment are discussed with reference to FIGS. 1A-1D, FIGS. 3A-3C, and FIGS. 5A-5B.

In some such embodiments, the total number of patches is greater than the total number of light-sensitive components.

In some such embodiments, at least 50% of the patches are in wired electrical connection with exactly two light-sensitive components.

In some such embodiments, the conductive patches are electrically isolated one from the other except through the light-sensitive components.

In some such embodiments, for a patch in wired electrical connection with two light-sensitive components, the connection is through opposite sides of the patch.

In some such embodiments, for a patch in wired electrical connection with two light-sensitive components (such as PIN or PN diodes), the patch is in wired electrical connection with an anode of a the light-sensitive component (the P electrode of a PIN or PN diode) and with a cathode of a different the light-sensitive component (the N electrode of a PIN or PN diode).

In some such embodiments, the patches are arranged on the upper dielectric surface in a two-dimensional array having n rows, wherein:
patches of a row are in wired electrical connection with a neighboring patch in the row through a single light-sensitive component;
each row has two edge patches in wired electrical connection with a single light-sensitive component;
each row has at least one internal patch, each such internal patch in wired electrical connection with an anode of a light-sensitive component and with a cathode of a different light-sensitive component; and
there is no wired electrical connection between any two the rows. Such an embodiment is discussed with reference to FIGS. 1A-1D.
   Wired Electrical Connection of Single Patch with a Single Light-Sensitive Component

In some embodiments, each one of the patches is in wired electrical connection with a single light-sensitive component. Such an embodiment is discussed with reference to FIGS. 2A-2B.

In some such embodiments, a light-sensitive component comprises two contacts, a first contact in wired electrical connection with a patch and a second contact in wired electrical connection with a conductive ground component. In some such embodiments, the patches are in wired electrical connection one with the other only through a conductive ground component.

In some such embodiments, an anode of the light-sensitive component (such as a PN or PIN diode) is in wired electrical connection with the patch and a cathode of the light-sensitive component is in wired electrical connection with a conductive ground component. Alternatively, in some such embodiments, a cathode of the light-sensitive component (such as a PN or PIN diode) is in wired electrical connection with the patch and an anode of the light-sensitive component is in wired electrical connection with a conductive ground component.

### Reverse Bias

In some embodiments, the light-sensitive components are in an open circuit with the patches and are not biased. Such embodiments are discussed with reference to FIGS. 1A-1D, FIGS. 2A-2B and FIGS. 5A-5B.

In some alternative embodiments, the light-sensitive components (e.g., PN or PIN diodes) are reverse-biased. Such embodiments are discussed with reference to FIGS. 3A-3C; and 4A-4C.

### Illumination Module

In some embodiments, a reflector according to the teachings herein comprises an illumination module configured to illuminate the light-sensitive components of the reflector with illumination light having a selected value for one or more of the light properties, e.g., a selected intensity and/or a selected color and/or selected polarization. In some such embodiments, a reflector further comprises a controller functionally associated with the illumination module to control activation of the illumination module in order to control the reflective properties of the microwave/MMW reflecting surface.

As discussed above, a reflector according to the teachings herein is tuned by illuminating the light-sensitive components of the reflector with illumination light having a selected value of a selected property such as intensity so as to set the electrical property of the light-sensitive component to a desired value, which ultimately leads to the constitution of a metasurface having the desired reflecting properties. Taken together, the light illuminating the different light-sensitive components can be considered as constituting an image.

In order to tune the reflector, that is to say, to change the metasurface to achieve different reflecting properties, the illumination light is changed, that is to say, one or more properties of light illuminating one or more of the light-sensitive components is changed.

In some preferred embodiments, changing of the illumination light comprises changing the intensity of the illumination light. In preferred such embodiments, the illumination light is monochromatic.

Additionally or alternatively, in some embodiments, changing of the illumination light comprises changing the color (wavelength or wavelength distribution) of the illumination light.

The illumination light is any suitable illumination light comprising any suitable wavelength or wavelengths that is typically dependent on the wavelength-dependent response of the light-sensitive components. In some typical embodiments where the light-sensitive components are PIN diodes, especially Ge, InGaAs or GaAs PIN diodes that have particularly fast response times to light having a 1300-1500 nm wavelength, the illumination light is produced by one or more NIR LEDs. NIR LEDs that produce light having wavelengths of ˜1000 nm to 1700 nm are commercially available.

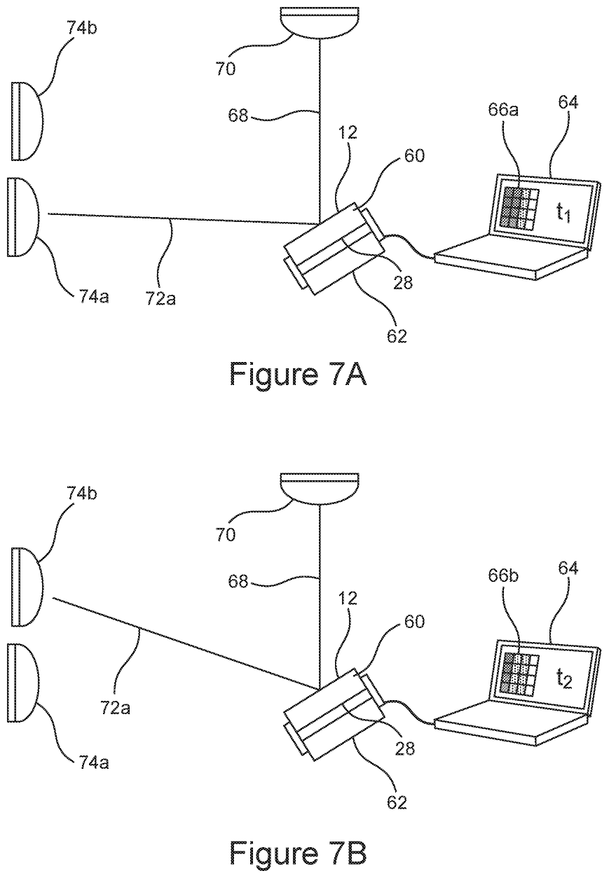

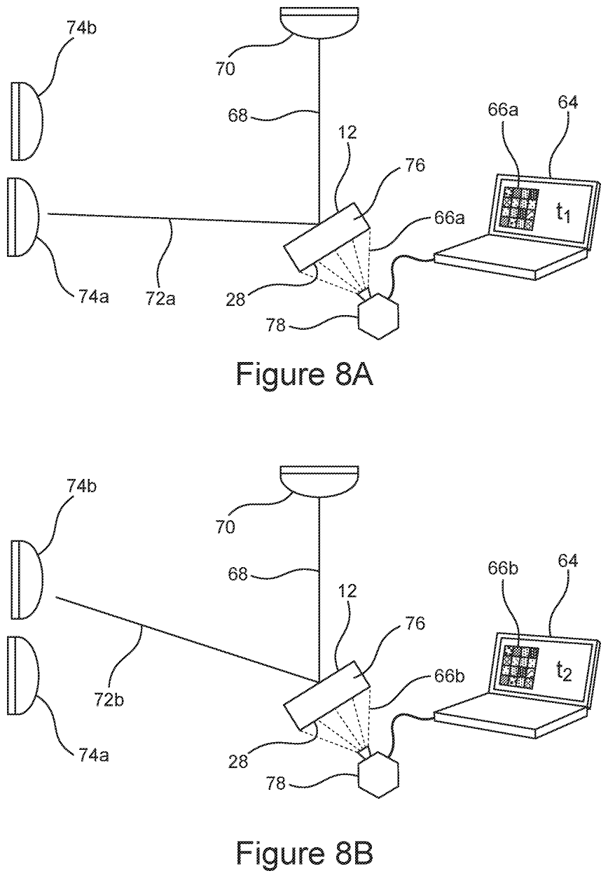

In some embodiments, an illumination module is configured to illuminate at least one group (each group comprising at least one light-sensitive component) of the light-sensitive components of the reflector with a chosen one of at least two different illumination light, allowing setting the electrical property of the light-sensitive components of the group to at least two different values. In some such embodiments (such as depicted in FIGS. 7A-7B and 8A-8B), each group includes exactly one light-sensitive component so that the value of the electrical property can be independently set for each light-sensitive component. The two different illumination lights differ in any suitable way so that illumination of the light-sensitive components therewith changes the electrical value of the property of the light-sensitive components in accordance with the teachings herein. Suitable ways the different illumination lights differ can include intensity, wavelength, polarization and combinations thereof, preferably intensity as the intensity of light is technically simple to quickly and accurately change between different fixed values.

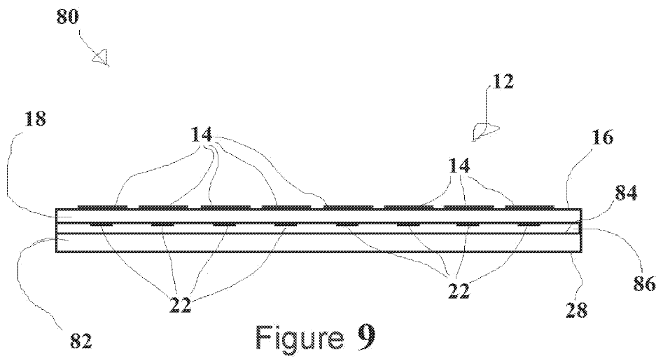

An exemplary commercially-available component that can be used as an illumination module or as a component of an illumination module is a 5-inch round screen 1080*1080 LCD display controller board (Catalogue Nr. TOP050MIPI10801080R) by Wisecoco Display (Longgang District, Shenzhen, China). In embodiments having a (front) reflector surface and a different (back) surface bearing the light-sensitive components, the component can be attached to the surface bearing the light-sensitive components, see FIG. 9 discussed below. In some such preferred embodiments, an illumination surface (a surface through which light emerges) of the illumination module is within 1 mm (and even contacts) a surface of a reflector that bears the light sensitive components, see FIG. 9 discussed below.

### Materials

In some embodiments, at least some patches are in wired electrical connection with a light-sensitive electronic component through a via. In some embodiments, some or all of the vias are solid conductive pegs (of any cross section). In some embodiments, some or all of the vias are hollow conductive tubes.

In some preferred embodiments, the dielectric substrate (and, if present, the second dielectric substrate) is any suitable dielectric rigid substrate that defines a planar surface. The substrate is made of any suitable material or combinations of materials having a dielectric strength of less than 400 V/micrometer. In some embodiments, the dielectric substrate comprises a dielectric material selected from the group consisting of polyester (300V/μm), polyimide (280V/μm), polycarbonate (250V/μm), polyethylene (200V/μm), polypropylene (200V/μm), polystyrene (200V/μm), polytetrafluoroethylene (90-180V/μm), epoxy resin (25-45V/μm) and poly(vinylidene fluoride) (10.2 V/μm), in some embodiments being composite materials that also include a reinforcing phase such as fibers. For example, in preferred embodiments, a dielectric substrate is a PCB substrate such as a fiber-reinforced thermoset resin known in the art of PCBs.

The patches, vias, leads and ground component of a reflector according to the teachings herein are all made of a conductive material. Any suitable material or combination of materials is independently selected for implementing these components. In some embodiments patches, vias, leads and ground component are made of a conductive material independent selected from the group consisting of copper, silver, gold, aluminum, zinc, nickel, iron, platinum and alloys thereof.

### Use of a Reflector

In some embodiments, after a reflector is made and prior to installation for use, the reflector is placed on a testing bench and functionally associated with an illumination module such as a LED array or image projector. A beam of microwaves or MMW is directed at the reflecting surface of the reflector and some, many or all combinations of possible combinations of light properties are used to illuminate the light-sensitive components (e.g., each such combination constituting an image) each combination inducing a different induced phase-shift and therefore reflection of the beam. A look-up table is generated for the specific reflector that allows an operator to select a specific combination of light intensities (e.g., each specific combination constituting an image) to provide the desired reflective properties.

An embodiment of a tunable reflector according to the teachings herein is discussed with reference to the exemplary embodiments depicted in FIGS. 1A-1D.

FIG. 1 schematically depict an exemplary reflector 10 in FIG. 1A (top view), FIG. 1B (side view from the x direction), FIG. 1C (side view from the y direction, cross section) and FIG. 1D (bottom view).

In FIG. 1A, a reflecting surface 12 of reflector 10 is a microwave/MMW reflecting metasurface comprising a 4×4 array of conductive copper patches 14 printed on a planar upper surface 16 of a first dielectric substrate 18 (a PCB board). Each copper patch 14 is a 1.36×1.36 mm square and 0.05 mm thick (in the z-direction). Neighboring patches 14 are separated by 0.24 mm. Upper dielectric surface 16 is a planar 6.4×6.4 mm square that defines the x-y plane of reflector 10. Upper dielectric surface 16 and patches 14 are coated with a microwave/MMW-transparent coating to prevent corrosion and wetting of patches 14. Patches 14 are arranged in four rows 20a, 20b, 20c and 20d of four patches 14 each, rows 20 oriented in the x-direction.

In FIG. 1B, reflector 10 is viewed from the side from the x-direction so that a single patch 14 and a single light-sensitive component 22 (an InGaAs PIN diode) from each one of four rows 20 is seen. Also seen is a conductive ground component, ground plate 24, of conductive material (0.05 mm thick copper) separating first dielectric substrate 18 from a second dielectric substrate 26 (a PCB board). In the z-direction, first dielectric substrate 18 is 0.508 mm thick and second dielectric substrate 26 is 0.127 mm thick. There is no electrical connection between the components of any two different rows or with conductive ground plate 24. Light-sensitive components 22 are arranged on a second dielectric surface 28 which is the lower, exposed, surface of second dielectric substrate 26.

In FIG. 1C, reflector 10 is viewed from the y-direction in cross-section A-B that bisects patches 14 of first row 20a. It is seen that each patch 14 is associated with two vias 30 (0.3 mm diameter) that pass through holes 32 (0.7 mm diameter). Outer vias 30′ of the two outer patches 14 pass through first dielectric substrate 18 and ground plate 24 to anchor into second dielectric substrate 26. All other vias 30 pass through first dielectric substrate 18, ground plate 24 and second dielectric substrate 26 to emerge on second dielectric surface 28. Electrically connecting any two vias 30 of any two neighboring patches 14 in the same row 20 is a light-sensitive component 22, which, as stated above, in reflector 10 are InGaAs PIN diodes. None of vias 30 contact ground plate 24 and are electrically isolated therefrom.

Accordingly, in reflector 10 a row 20 of four patches 14 is associated with three light-sensitive components 22. All light-sensitive components 22 are oriented in the same direction, that is to say, a P-contact (anode) 34 of a first PIN diode being in electrical contact with an N-contact 36 (cathode) of a second PIN diode through two vias 30 and a patch 14.

In FIG. 1D, reflector 10 is seen from the bottom. Light-sensitive components 22 are seen arranged on second dielectric surface 28 in four rows 20a, 20b, 20c and 20d, with P-contacts (anode) 34 and N-contacts (cathode) 36 contacting vias 30 that emerge through second dielectric substrate 26. In FIG. 1D, dashed lines indicate the location of patches 14 on upper dielectric surface 16: patches 14 are not apparent on second dielectric surface 28. As is seen in FIG. 1D, reflector 10 has a greater number of patches 14 than light-sensitive components 22.

A second embodiment of a reflector of the teachings herein, reflector 38 is schematically depicted in FIG. 2A (side view from the y direction, cross section) and FIG. 2B (bottom view). In top view and in side view from the x-direction, reflector 38 appears identical to reflector 10 as depicted in FIG. 1A and FIG. 1B, respectively.

In FIG. 2A, reflector 38 is viewed from the y-direction in a cross-section that bisects patches 14 of first row 20a. It is seen that each patch 14 is associated with a single via 30a that passes through a hole 32 in first dielectric substrate 18, ground plate 24 and second dielectric substrate 26 to electrically connect to a P-contact (anode) 34 of a light-sensitive component 22 (an InGaAs PIN diode). In reflector 38, none of vias 30a that are electrically connected to a patch 14 contact ground plate 24 and are all electrically isolated therefrom.

The N-contacts (cathode) 36 of light-sensitive components 22 each contact a via 30b that passes through a hole 32 in second dielectric substrate 26, emerges through second dielectric substrate 26 and electrically connects to ground plate 24.

In reflector 38, a row of patches 14 such as row 20a has an equal number of light-sensitive components 22 as patches 14. All light-sensitive components 22 are oriented in the same direction, that is to say, for all light-sensitive components 22, a P-contact 34 is in electrical contact with a patch 14 through a via 30a and an N-contact 36 is in electrical contact with ground plate 24 through a via 30b. In a non-depicted variant of reflector 38, the orientation of the light-sensitive components 22 is different: for all light-sensitive components 22, for all light-sensitive components 22, an N-contact 36 is in electrical contact with a patch 14 through a via 30a and a P-contact 34 is in electrical contact with ground plate 24 through a via 30b.

In FIG. 2B, reflector 38 is seen from the bottom. Light-sensitive components 22 are seen arranged on second dielectric surface 28 in four rows 20a, 20b, 20c and 20d, with P-contacts 34 and N-contacts 36 contacting vias that emerge through second dielectric substrate 26. In FIG. 2B, dashed lines indicate the location of patches 14 on upper dielectric surface 16: patches 14 are not apparent second dielectric surface 28. As is seen in FIG. 2B, reflector 38 has an equal number of patches 14 as light-sensitive components 22.

In FIGS. 3A, 3B and 3C, three variants of reflector 10 (discussed with reference to FIGS. 1A-1D) are schematically depicted in bottom view, all three implementing reverse bias of light-sensitive components 22.

In FIG. 3A, reflector 40 comprises a single variable-voltage DC power supply 42. An anode 44 of power supply 42 is in electrical connection with P-contacts (anode) 34 of all light-sensitive components 22. A cathode 46 of power supply 42 is in electrical connection with N-contacts (cathode) 36 of all light-sensitive components 22. As a result, all light-sensitive components 22 can be reverse-biased with the same voltage, which voltage can be varied.

In FIG. 3B, reflector 48 comprises three different variable-voltage DC power supplies 42a, 42b and 42c. Each one of power supplies 42 is in electrical connection with four light-sensitive components 22, each one of the four light-sensitive components 22 belonging to a different row of patches 20. As with reflector 40, an anode 44 of a power supply 42 is in electrical connection with P-contacts 34 of a light-sensitive components 22 and a cathode 46 of a power supply 42 is in electrical connection with N-contacts 36 of a light-sensitive components 22.

In FIG. 3C, reflector 50 comprises twelve different variable-voltage DC power supplies 42. Each one of the twelve power supplies 42 is in electrical connection with a single light-sensitive component 22, an anode 44 of a power supply 42 in electrical connection with a P-contact 34 of a light-sensitive components 22 and a cathode 46 of a power supply 42 in electrical connection with an N-contact 36 of a light-sensitive components 22. As a result, each light-sensitive component 22 can be reverse-biased with an independent voltage, which voltage can be varied. Such embodiments are exceptionally useful in embodiments when the reflector is used for beam-shaping.

In FIGS. 4A, 4B and 4C, three variants of reflector 38 (discussed with reference to FIG. 2) are schematically depicted in bottom view, all three implementing reverse bias of light-sensitive components 22.

In FIG. 4A, reflector 52 comprises a single variable-voltage DC power supply 42. An anode 44 of power supply 42 is in electrical connection with P-contacts (anode) 34 of all light-sensitive components 22. A cathode 46 of power supply 42 is in electrical connection with N-contacts (cathode) 36 of all light-sensitive components 22. As a result, all light-sensitive components 22 can be reverse-biased with the same voltage, which voltage can be varied.

In FIG. 4B, reflector 54 comprises four different variable-voltage DC power supplies 42. Each one of power supplies 42 is in electrical connection with four light-sensitive components 22, each one of the four light-sensitive components 22 belonging to a different row of patches 20. As with reflector 52, an anode 44 of a power supply 42 is in electrical connection with P-contacts 34 of a light-sensitive components 22 and a cathode 46 of a power supply 42 is in electrical connection with N-contacts 36 of a light-sensitive components 22.

In FIG. 4C, reflector 56 comprises sixteen different variable-voltage DC power supplies 42. Each one of the sixteen power supplies 42 is in electrical connection with a single light-sensitive component 22, an anode 44 of a power supply 42 in electrical connection with a P-contact 34 of a light-sensitive components 22 and a cathode 46 of a power supply 42 in electrical connection with an N-contact 36 of a light-sensitive components 22. As a result, each light-sensitive component 22 can be reverse-biased with an independent voltage, which voltage can be varied. Such embodiments are exceptionally useful in embodiments when the reflector is used for beam-shaping.

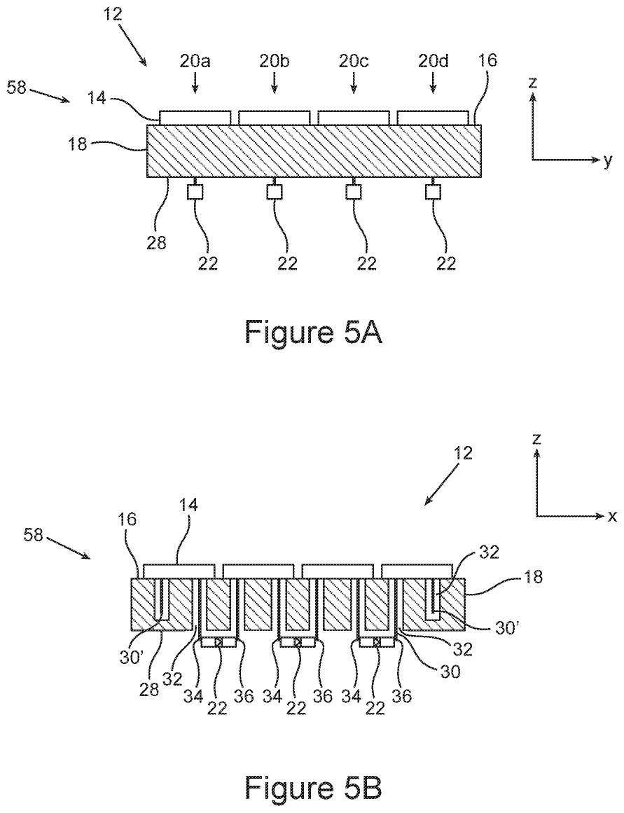

The specific embodiments of a reflector according to the teachings herein described with reference to FIGS. 1A-1D, 2A-2B, 3A-3C and 4A-4C all included two substrate boards, first dielectric substrate 18 and second dielectric substrate 26, separated by a conductive ground component, ground plate 24. An exemplary reflector 58 is schematically depicted in FIG. 5A (side view from the x direction) and FIG. 5B (side view from the y direction, cross section). Reflector 58 includes a single substrate board 18 having a first planar surface that is an upper dielectric surface 16 of reflector 58 and a second planar surface that is a second dielectric surface 28 of reflector 58. Reflector 58 is devoid of a conductive ground component.

The specific embodiments of a reflector according to the teachings herein described with reference to FIGS. 1A-1D, 2A-2B, 3A-3C, 4A-4C and 5A-5B all included sixteen equal-sized square patches, arranged on a dielectric surface in a square-packed arrangement of n=4 rows, each row including four patches. As noted above and as is clear to a person having ordinary skill in the art of metasurfaces upon perusing the description herein, in some embodiments a reflector has one or more of different sized-patches and/or patches having a shape different than square and/or fewer/a greater number of patches, arranged in any suitable way on a dielectric surface. For example, In FIG. 6, a reflector 59 is schematically depicted in top view where thirty-seven circular patches 14 are arranged on an upper dielectric surface 16 in a hexagonal-packed arrangement.

In FIGS. 7A and 7B is depicted an exemplary reflector 60 according to the teachings herein comprising an illumination module that includes an image projector 62, image projector 62 functionally associated with a controller 64, a software-configured general-purpose computer.

Reflector 60 is any suitable reflector according to the teachings herein having sixteen light-sensitive components arranged in a 4×4 array on a second dielectric surface, for example, reflector 10 depicted in FIG. 1 or reflector 38 depicted in FIG. 2.

Image projector 62 comprises sixteen NIR/VIS LEDS (near-infrared/visible light emitting diodes) arranged in a 4×4 array and is configured so that when activated, the light produced by any given one of the sixteen NIR LEDs illuminates only a single specific one of the sixteen light-sensitive components arranged on a second dielectric surface 28 of reflector 60. The intensity of light produced by any one of the sixteen LEDs is independently controllable to illuminate a corresponding light-sensitive electronic components with a selected one of sixteen discrete intensities of light. Each combination of sixteen intensities for each one of the sixteen LEDs constitutes an image.

Controller 64 includes a stored look-up table of the reflective properties of the metasurface constituted by illuminating the light-sensitive electronic components of reflector 60 with any one of the images.

In FIG. 7A, at a first time t₁, controller 64 activates image projector 62 to illuminate the light-sensitive components of reflector 60 with a first image 66a that leads to generation of a metasurface on a reflecting surface 12 of reflector 60, which metasurface reflects an incident microwave beam 68 from a microwave transmitter 70 in a first direction as a reflected beam 72a towards a first receiver 74a.

In FIG. 7B, at a second time t₂, controller 64 activates image projector 62 to illuminate the light-sensitive components of reflector 60 with a second image 66b different from first image 66a that leads to generation of a metasurface on reflecting surface 12 of reflector 60, which metasurface reflects incident microwave beam 68 in a second direction as a reflected beam 72b towards a second receiver 74b.

In FIGS. 7A and 7B, images 66a and 66b consist of sixteen pixels arranged in a 4×4 matrix where the different shadings in FIGS. 7A and 7B represent different light intensities emitted by a corresponding LED of image projector 62.

In FIGS. 8A and 8B is depicted an exemplary reflector 76 according to the teachings herein comprising an illumination module that includes an image projector 78 (a standard commercially-available pixelated image projector such as an AAXA P7 HD commercially available from AAXA Technologies, Inc., Irvine, California, USA), image projector 78 functionally associated with a controller 64, a software-configured general-purpose computer.

In FIG. 8A, image projector 78 is positioned to project an image 66a on a second dielectric surface 28 of reflector 76 on which the light-sensitive components of reflector 76 are arranged. Controller 64 includes a stored look-up table of the reflective properties of the metasurface generated on a reflecting surface 12 of reflector 76 when the light-sensitive electronic components of reflector 76 are illuminated with different images projected by image projector 78.

In FIG. 8A, at a first time t₁, controller 64 activates image projector 78 to illuminate the light-sensitive components of reflector 76 with a first image 66a that leads to generation of a metasurface on reflecting surface 12 of reflector 76 which metasurface reflects an incident microwave beam 68 from a microwave transmitter 70 in a first direction as a reflected beam 72a towards a first receiver 74a.

In FIG. 8B, at a second time t₂, controller 64 activates image projector 78 to illuminate the light-sensitive components of reflector 76 with a second image 66b different from first image 66a that leads to generation of a metasurface on reflecting surface 12 of reflector 76, which metasurface reflects incident microwave beam 68 in a second direction as a reflected beam 72b towards a second receiver 74b.

In FIG. 9 is depicted a reflector 80 in side view functionally-associated with a display screen 82 as a component of an illumination module. Any suitable display screen can be used for example, a 5-inch round screen 1080*1080 LCD display controller board (Catalogue Nr. TOP050MIPI10801080R) by Wisecoco Display (Longgang District, Shenzhen, China). Reflector 80 is made using semiconductor methods including a dielectric substrate 18, a silicon chip which is substantially a complete round 100 mm diameter/525 micrometer thick wafer of silicon. Top surface 12 of reflector 80 has a surface area of 7854 mm². The 100 mm diameter makes reflector 80 particularly suitable for reflecting electromagnetic radiation having a wavelength of up to about 10 mm (i.e., frequencies of about 30 GHz and higher). Substrate 18 has an upper first dielectric surface 16 and a lower second dielectric surface 28. On second dielectric surface 28 are a plurality of light-sensitive components 22, substantially gallium arsenide (GaAs) PIN photodiodes. On upper dielectric surface 16 of substrate 18 are found a plurality of metal conductive patches 14, each patch 14 in wired electrical connection with a light-sensitive component 22 by at least one through-silicon via (TSV) so that upper dielectric surface 16 is the microwave/MMW-reflecting surface 12 of reflector 80. An illuminating front face 84 of display screen 82 is attached to reflector 80 through second dielectric surface 28 using a 160 micrometer thick circle of transparent double-sided adhesive film 86. Patches 14, light-sensitive components 22 and the TSV are all made using known semiconductor fabrication methods. The dimensions and shapes of patches 14 determine the reflected frequencies. For example, in embodiments where patches 14 have dimensions of about 2.5 mm, reflector 80 can have about 1500 patches and is suitable for reflecting frequencies of around 30 GHz. For example, in embodiments where patches 14 have dimensions of about 0.25 mm, reflector 80 can have about 150,000 patches and is suitable for reflecting frequencies of around 300 GHz.

In FIG. 10A is depicted a reflector 84 made up of seven different dielectric substrates 18. Each dielectric substrate 18 is a silicon chip made up of a single 450 mm diameter/925 micrometer thick wafer having an upper dielectric surface 16 with a plurality of conductive patches (not depicted) in wired electrical connection through TSVs with a plurality of light-sensitive components on a back side of the chip, substantially as described for reflector 80 with reference to FIG. 9. The seven dielectric substrates 18 are connected to a framework 86 which ensures that substrates 18 are all coplanar and have a desired separation in the depicted hexagonal packing. The vertex-to-vertex dimension of reflector 84 is 1350 mm and the side-to-side dimension is 1169 mm so that reflector 84 has a reflective surface of about 1100 mm, suitable for reflecting beams having a wavelength of up to about 110 mm (2.7 GHZ).

In FIG. 10B is depicted a reflector 88 made up of one hundred different dielectric substrates 18 (only one labeled). Each dielectric substrate 18 is a 350 mm×350 mm PCB board having an upper dielectric surface 16 with a plurality of conductive patches (not depicted) in wired electrical connection through vias with a plurality of light-sensitive components on a back side of the board. The one hundred dielectric substrates 18 are connected to a framework (not depicted) which ensures that substrates 18 are all coplanar and have a desired separation in the depicted square packing. The side-to-side dimension of reflector 88 is 3500 mm so that reflector 84 has a reflective surface of about 3500 mm, suitable for reflecting beams having a wavelength of up to about 350 mm (0.85 GHz).

### Experimental

### Reflector Design and Construction

An experimental reflector according to the teachings herein, similar to reflector 38 as discussed above with reference to FIGS. 2A and 2B was simulated using CST electromagnetic field simulation software by Dassault Systems and demonstrated successful two-dimensional steering of an electromagnetic beam, as detailed in the attached Appendix. In the attached Appendix some components may be referred to using terminology that is different than used in this description. A person having ordinary skill in the art is able to understand the attached Appendix and the referred-to components. The attached Appendix also describes additional embodiments and features of the teachings herein. In the attached Appendix are listed 44 references: at least some of the references provide general background and are not relevant to the patentability of the claims.

In the experimental reflector, the first dielectric substrate was a 0.508 mm thick PCB board.

In the experimental reflector, the second dielectric substrate was a 0.127 mm thick PCB board.

In the experimental reflector, the conductive ground component was a 0.05 mm thick layer of copper disposed between and separating the first substrate and the second substrate. The conductive ground component was continuous except where perforated with holes allowing the passage of vias as described below.

Instead of sixteen patches like depicted for reflector 12 in FIGS. 2A-2B, the experimental reflector has 256 patches arranged in a square-packed array of sixteen rows each row comprising sixteen patches on the upper surface of the first dielectric substrate.

Each patch was a 1.36 mm×1.36 mm square, 0.05 mm thick layer of copper. Neighboring patches were separated by 0.24 mm.

Each patch was in wired electrical connection with the anode of a SFH 2704 Silicon PIN photodiode through a 0.3 mm solid via that passed through a 0.7 mm hole that passed through the first substrate, the conductive ground component and the second substrate.

The cathode of each SFH 2704 Silicon PIN photodiode was in wired electrical connection with the conductive ground component through a 0.3 mm solid via that passed through a 0.7 mm hole that passed through the second dielectric substrate.

Unless otherwise defined, all technical and scientific terms used herein have the same meaning as commonly understood by one of ordinary skill in the art to which the invention pertains. In case of conflict, the specification, including definitions, takes precedence.

As used herein, the terms “comprising”, “including”, “having” and grammatical variants thereof are to be taken as specifying the stated features, integers, steps or components but do not preclude the addition of one or more additional features, integers, steps, components or groups thereof. As used herein, the indefinite articles “a” and “an” mean “at least one” or “one or more” unless the context clearly dictates otherwise.

As used herein, when a numerical value is preceded by the term “about”, the term “about” is intended to indicate +/−10%. As used herein, a phrase in the form “A and/or B” means a selection from the group consisting of (A), (B) or (A and B). As used herein, a phrase in the form “at least one of A, B and C” means a selection from the group consisting of (A), (B), (C), (A and B), (A and C), (B and C) or (A and B and C).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Embodiments of methods and/or devices described herein may involve performing or completing selected tasks manually, automatically, or a combination thereof. Some methods and/or devices described herein are implemented with the use of components that comprise hardware, software, firmware or combinations thereof. In some embodiments, some components are general-purpose components such as general purpose computers, digital processors or oscilloscopes. In some embodiments, some components are dedicated or custom components such as circuits, integrated circuits or software.

For example, in some embodiments, some of an embodiment is implemented as a plurality of software instructions executed by a data processor, for example which is part of a general-purpose or custom computer. In some embodiments, the data processor or computer comprises volatile memory for storing instructions and/or data and/or a non-volatile storage, for example, a magnetic hard-disk and/or removable media, for storing instructions and/or data. In some embodiments, implementation includes a network connection. In some embodiments, implementation includes a user interface, generally comprising one or more of input devices (e.g., allowing input of commands and/or parameters) and output devices (e.g., allowing reporting parameters of operation and results.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

1-40. (canceled)

41. A method for reflecting microwaves and/or millimeter waves (MMWs) in a desired direction comprising:
a. providing a reflecting surface comprising a plurality of conductive patches on a surface of a dielectric substrate, each said conductive patch in wired electrical connection with at least one light-sensitive electronic component having an electrical property that is dependent on a property of light illuminating said light-sensitive component, where the values of said electrical property of said light-sensitive components collectively determine a phase-shift that said reflecting surface induces in an incident microwave/MMW beam which induced phase-shift determines the direction in which an incident beam is reflected; and
b. illuminating each said light-sensitive component with a selected value of the property of light so as to set said electrical property to a desired value,
so that a phase-shift is induced in an incident microwave/MMW beam to reflect said beam in a desired direction.

42. The method of claim 41, wherein a said electrical property that is dependent on the property of light illuminating said light-sensitive component is selected from the group consisting of capacitance, phase, permittivity, inductance and combinations thereof.

43. The method of claim 41, wherein said light-sensitive components are selected from the group consisting of a PN diode, a PIN diode, a PPD, a CCD, a photoresistor, a phototransistor and a Schottky Barrier Photodiode.

44. The method of claim 41, wherein said illumination light comprises light having a wavelength of between 400 micrometers and 2000 micrometers.

45. The method of claim 41, wherein said light-sensitive components are arranged on a surface and said illuminating comprises projecting an image on said surface so that each said light-sensitive component is illuminated with a corresponding selected value of the property of light.

46. The method of claim 41, wherein said plurality of patches are arranged on said surface of said dielectric substrate in a two-dimensional array having n rows, each said row having m said patches, n and m being integers of at least 2.

47. The method of claim 46, wherein adjacent said patches in a same said row are in wired electrical connection through a said light-sensitive components and said patches are electrically isolated from patches in a different said row.

48. The method of claim 41, wherein each said light-sensitive component is in wired electrical connection with a single said patch and with a conductive ground component.

49. A tunable microwave and/or millimeter wave (MMW) reflector, comprising:
a plurality of light-sensitive components having an electrical property that is dependent on a property of light illuminating said light-sensitive component; and
a microwave/MMW-reflecting surface including:
a dielectric substrate defining an upper dielectric surface,
on said upper dielectric surface, a plurality of conductive patches, each said conductive patch in wired electrical connection with at least one said light-sensitive component,
where the values of said electrical property of said light-sensitive components collectively determine a phase-shift that said reflecting surface induces in an incident microwave/MMW beam which induced phase-shift determines the direction in which an incident beam is reflected.

50. The reflector of claim 49, wherein a said electrical property that is dependent on the value of the property of light illuminating said light-sensitive component is selected from the group consisting of capacitance, phase, permittivity, inductance and combinations thereof.

51. The reflector of claim 49, wherein said light-sensitive components are selected from the group consisting of a PN diode, a PIN diode, a PPD, a CCD, a photoresistor, a phototransistor and a Schottky Barrier Photodiode.

52. The reflector of claim 49, wherein said dielectric substrate is a board having a first planar surface that is said upper dielectric surface and a second planar surface that is a planar lower surface of said board.

53. The reflector of claim 47, wherein said dielectric substrate is a chip of semiconductor material.

54. The reflector of claim 49, further comprising a second dielectric surface on which said light-sensitive components are arranged.

55. The reflector of claim 49, wherein said patches each covers a surface area of not less than 0.025 mm² (0.5 mm×0.5 mm) and not more than 100 mm² (10 mm×10 mm) of said upper dielectric surface.

56. The reflector of claim 49, wherein at least 50% of said patches are in wired electrical connection with two said light-sensitive components.

57. The reflector of claim 49, wherein each one of said patches is in wired electrical connection with a single said light-sensitive component.

58. The reflector of claim 49, further comprising an illumination module configured to illuminate said light-sensitive components with said illumination light.

59. The reflector of claim 58, said illumination module configured to illuminate at least one group of said light, each group comprising at least one light-sensitive component with a chosen one of at least two different said illumination lights, allowing setting said electrical property to at least two different said values.
